(19) United States
(12) Patent Application Publication
(10) Pub. No.: US 2015/0273477 A1
(43) Pub. Date: Oct. 1, 2015

(54) GROOVED INCISOR SHREDDER CUTTING BLADE SET AND METHOD

(71) Applicants: KEVIN CHEN, Ranch Palos Verdes, CA (US); Chung Shih Tsai, Hawthome, CA (US); Wei Hsin Chen, Shanghai (CN); Hsin-Hsiung Chen, Shanghai (CN)

(72) Inventors: KEVIN CHEN, Ranch Palos Verdes, CA (US); Chung Shih Tsai, Hawthome, CA (US); Wei Hsin Chen, Shanghai (CN); Hsin-Hsiung Chen, Shanghai (CN)

(73) Assignee: AURORA OFFICE EQUIPMENT CO., LTD., Shanghai (CN)

(21) Appl. No.: 14/686,508

(22) Filed: Apr. 14, 2015

Related U.S. Application Data
(63) Continuation-in-part of application No. 13/480,392, filed on May 24, 2012.
Application No. 13/480,392 is a continuation-in-part of application No. 13/506,423, filed on Apr. 18, 2012, now Pat. No. 8,646,714.

(30) Foreign Application Priority Data
Oct. 25, 2011 (CN) 201110327535.6

(51) Int. Cl. B02C 18/18; B02C 18/00; B23P 15/40; B21D 37/20; B21D 39/03

(52) U.S. Cl. CPC B02C 18/182; B21D 37/205; B21D 39/031; B23P 15/406; B02C 18/0007

(57) ABSTRACT

A grooved incisor blade set for paper shredders is disclosed. A blade includes a crown, a groove juxtaposed with the crown, and a center hole for a cutting arbor, where the crown and the groove define a relief channel. A stair-shaped, U-shaped or V-shaped blade assembly is described. In one embodiment, a notched grooved incisor blade having notches proximate to the central hole comes in contact with a mating grooved incisor blade also having a central hole. Force is applied to the mating blade to displace some of the body of the mating blade into the notches, affixing the blades together. A method for forming shredder cutting blades includes providing a strip of metal, forming a crown in the strip of metal, forming a relief groove juxtaposed to the crown in the strip of metal, thereby forming a relief channel, and trimming the grooved incisor blade of excess metal.

### CROSS-REFERENCE TO RELATED APPLICATIONS

This applications is a continuation-in-part of U.S. application Ser. No. 13/480,392, filed 24 May 2012, and entitled “GROOVED INCISOR SHREDDER CUTTING BLADE SET AND METHOD,” which a continuation-in-part of U.S. application Ser. No. 13/506,423, filed on 18 Apr. 2012, and entitled “NOVEL PAPER SHREDDER CUTTING BLADE SET,” now U.S. Pat. No. 8,646,714, issued 8 Feb. 2014, which claims foreign priority to CN 201110327535.6, filed 25 Oct. 2011, and entitled “NOVEL PAPER SHREDDER CUTTING BLADE SET,” which hereby are incorporated by reference in their respective entirety.

### FIELD OF THE INVENTION

The present invention relates to shredder blades. More particularly to a blade set comprised of two blades, forming a grooved incisor blade set.

### BACKGROUND

Paper shredding machines perform a valuable function in destroying documents that otherwise might be misused. Even though there are many varieties and special functions of these machines, they typically all rely upon cutting blades to shred the documents.

The cutting blades must be sturdy enough to withstand the rigor of shredding a great deal of paper. Also, the blades must be economical to produce and easy to incorporate into the paper shredders to enable a low cost of manufacturing.

In many shredders, the assembled cutter structure can be a combination of single blades and blade sets where the blade sets are made of usually two blades affixed together. This arrangement has proven quite successful and efficient in the shredder industry.

There are a number of ways to affix two blades together to arrive at a blade set. These processes could include forms of welding that permanently affix the blades together, or mechanical attachments between the blades where the blades could be remove from one another rather easily.

It is desirable to have the blades more permanently affixed, but processes like welding can be costly and time consuming. What is needed is a way to affix two blades together in a relatively permanent fashion that is less costly and less time consuming than current methods.

Conventional cutting blades tend to become less efficient, as the space between the blades in a set decreases, and become jammed with shredded paper particles. This forces the shredder to work harder to oppose the growing jam, which may occur even below the sheet feed limit of the shredder. Moreover, the jammed paper particles have a tendency to spread apart blade sets, causing blade warping, effortful shredding and, eventually, blade failure. What is needed is a way to relieve the accumulation of shredded paper particles so that shredder effort is reduced and the likelihood of a shredder blade set failure is minimized.

### SUMMARY OF THE INVENTION

A shredder blade is disclosed having a single piece disk-shaped body having an external face with a first flat surface, an internal face with a second flat surface opposite the external face and the first flat surface, and a circumferential periphery with a thickness. The shredder blade has a central hole in the disk-shaped body penetrating the external and internal faces, and a cutting crown protruding from the circumferential periphery of the disk-shaped body. A cutting tip extends from the cutting crown body and does not protrude over the first flat surface or the second flat surface. The shredder blade also includes a grooved portion in the circumferential periphery extending at least partly through the thickness from the exterior face to the interior face, in which the grooved portion is a relief groove. The shredder blade further includes a dam raised up from the grooved portion and transverse on the circumferential periphery adjacent to the cutting crown, wherein the grooved portion relieves cutting forces on the cutting crown. The crown portion and the groove portion are formed from a strip of metal and define a relief channel. The groove portion can be one of a rectilinear shape, a stair-step shape, a curvilinear shape, or an arcuate shape. Each side of a blade is a flat surface. No portion of the blade protrudes over either flat surface of the blade.

Forming may be by stamping, punching, or forging. The crown portion can have a beveled edge. Cutting points, and a dam, also are included with embodiments of the incisor. The crown portion of a blade is formed with a predetermined crown height, and a predetermined crown beam.

Also provided is a blade assembly, having a first crown portion of a first blade, a first groove portion of the first blade juxtaposed with the first crown portion, a second groove portion of a second blade in apposition to the first groove portion of the first blade, and a second crown portion of the second blade juxtaposed with the second groove portion of the second blade. The first blade is affixed to the second blade. The assembly can be stepped shape, a V-shape, or a U-shape, or other suitable shapes.

In some embodiments, a cutting point is provided on each of the first crown portion and the second crown portion. In addition, a dam can be advanced from the cutting point. Methods for forming and assembling shredder cutting blades are included. A embodiment of a method for forming shredder cutting blades includes providing a strip of metal, forming an crown in the strip of metal, forming a relief groove juxtaposed to the crown in the strip of metal, and trimming the grooved crown blade of excess metal. Forming the relief groove forms a relief channel. In an embodiment, straightening a rolled strip of metal is performed before providing a strip of metal. The method may include heat-treating the grooved incisor blade.

In some embodiments, forming the crown is by stamping. Forming the relief groove is by the stamping the relief groove juxtaposed to the crown in one of a rectilinear or a curvilinear shape. In selected embodiments, the cutting crown means and the relief groove means are formed from a single piece of metal. A dam means is transverse to the cutting crown means and the relief groove means. In addition, cutting point means are disposed generally transverse to the cutting crown means and to the relief groove means with the dam means being disposed advanced of the cutting point means. In certain embodiments, the shredder blades are formed into an assembly by affixing first and second grooved incisor blades into an assembly, using notched blade locking.

In yet other embodiments, a paper shredder blade set is provided, including a first crown portion of a first blade, a first groove portion of the first blade juxtaposed with the first crown portion and having a notch, forming a notched grooved incisor blade. The notched grooved incisor blade has a substantially round and shaped body, first and second opposing flat sides, a center hole adapted to receive a cutting arbor, at least two crowns disposed on a periphery of the set body, and at least two notches with each notch extending from a point in the body to the center hole and through the flat sides. The set also includes a second groove portion of a second blade in apposition to the first groove portion of the first blade, and a second crown portion of the second blade juxtaposed with the second groove portion of the second blade, forming a mating grooved incisor blade set, or assembly. The mating grooved incisor blade has a substantially round and flat shaped body, first and second opposing flat sides, a center hole adapted to receive a cutting arbor, and at least two cutting points disposed on a periphery of the body. The first flat side of the notched grooved incisor blade contacts the first flat side of the mating grooved incisor blade such that each of the cutting points on the notched grooved incisor blade substantially align with a corresponding cutting point on the mating grooved incisor blade and a groove is formed therebetween.

If present, a dam on the first blade is aligned with a dam on the second blade. Also, an amount of the material from the body of the mating grooved incisor blade is disposed within the notch of the notched grooved incisor blade such that a portion of the amount of material in the notch remains attached to the mating grooved incisor blade, and the notched grooved incisor blade and the mating grooved incisor blade are substantially secured to one another.

In still another embodiment, a method of manufacturing a paper shredder blade set using a notched grooved incisor blade having a substantially round and flat shaped body, a first and second opposing flat sides, a center hole adapted to receive a cutting arbor, at least two cutting points disposed on a periphery of the body, and at least two notches with each notch extending from a point in the body through the center hole and through the flat sides, and a mating grooved incisor blade having a substantially round and flat shaped body, a first and second opposing flat sides, the center hole adapted to receive a cutting arbor, and at least two cutting points disposed on a periphery of the body, is provided, including placing the first flat side of the notched grooved incisor blade in contact with the first flat side of the mating grooved incisor blade such that each crown on the notched grooved incisor blade substantially aligns with a corresponding crown on the mating grooved incisor blade; and applying force to the second side of the mating grooved incisor blade in a location generally opposite the notch in the notched grooved incisor blade such that an amount of the material from the body of the mating grooved incisor blade is disposed within the notch of the notched grooved incisor blade such that a portion of the material in the notch remains attached to the mating grooved incisor blade, the notched grooved incisor blade and the mating grooved incisor blade are substantially secured to one another, and a groove having a relief channel is formed between the notched grooved incisor blade and the mating grooved incisor blade.

### BRIEF DESCRIPTION OF THE DRAWINGS

The invention is generally shown by way of reference to the accompanying drawings in which:

FIG. 1 is a perspective view of a prior art blade set;

FIG. 2 is a perspective view of a blade with notches;

FIG. 3 is a perspective view of a blade without notches;

FIG. 4 is a side view highlighting the flat sides of the blades;

FIG. 5 is a perspective view of a blade set having a V shaped blade formed from two blades;

FIG. 6 is a cutaway side view of the notched blade in contact with the mating blade;

FIG. 7 is a cutaway side view of the notched blade in contact with the mating blade with material from the mating blade being disposed within the notch;

FIG. 8 is an edge view of a shredder blade set embodiment having a V-shaped profile, in accordance with the teachings of the present invention;

FIG. 9 is an edge view of a shredder blade set embodiment having a U-shaped profile, in accordance with the teachings of the present invention;

FIG. 10 is an edge view of a shredder blade set embodiment having a stair-step-shaped profile, in accordance with the teachings of the present invention;

FIG. 11 is an edge view of a shredder blade set embodiment having a dam and cutting points, in accordance with the teachings of the present invention;

FIG. 12 is a perspective view of a stepped shredder blade set embodiment joined to form a blade assembly, in accordance with the teachings of the present invention;

FIG. 13 is a side cutaway view of a blade of the stepped blade set embodiment, in accordance with the teachings of the present invention;

FIG. 14 is a perspective view of a U-shaped blade embodiment having a cutting point and a dam, in accordance with the teachings of the present invention;

FIG. 15A-D are pictorial illustrations of a method embodiment, in accordance with the teachings of the present invention; and

FIG. 16 is a block diagram of a method embodiment, in accordance with the teachings of the present invention.

### DETAILED DESCRIPTION OF THE INVENTION

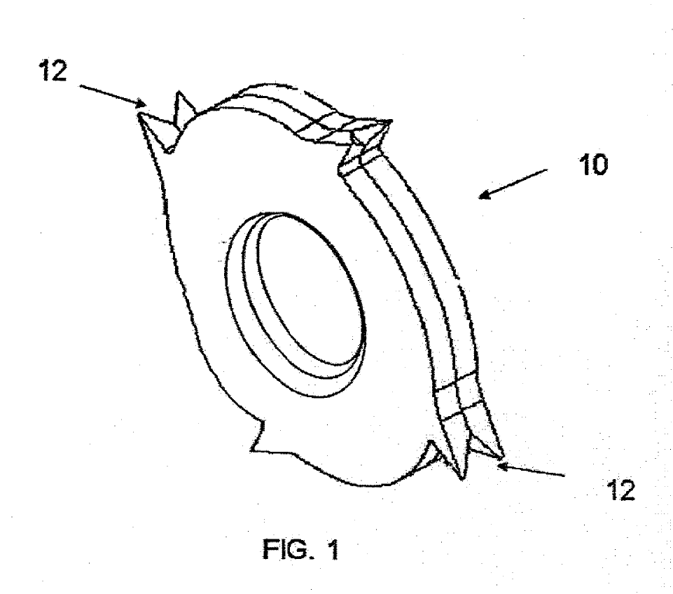

FIG. 1 is an example of two blades joined together to form a blade set (10) with a V shaped blade tips (12) as might be found in the prior art. The blades are could be joined by welding or other such methods. Each blade also has a hole to retain an arbor. In the figure, the holes are generally in alignment.

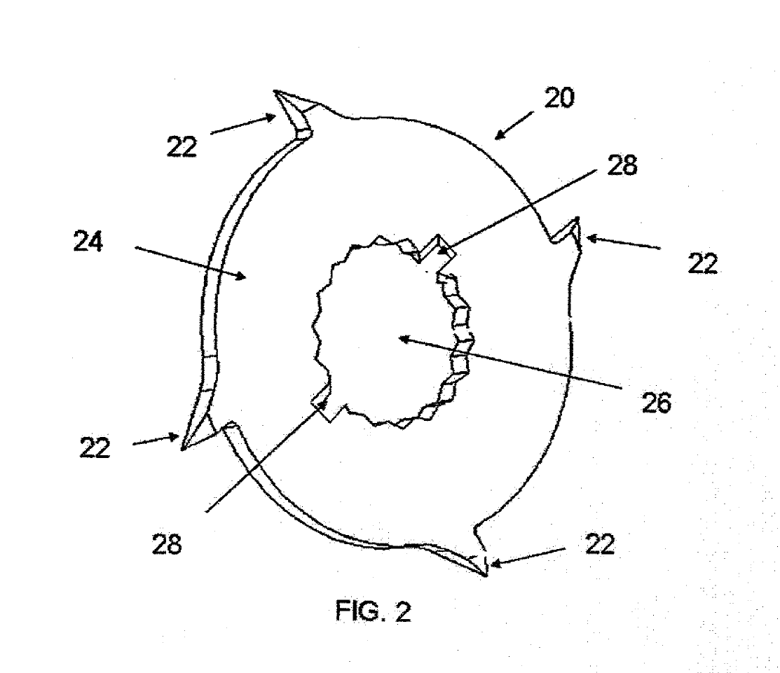

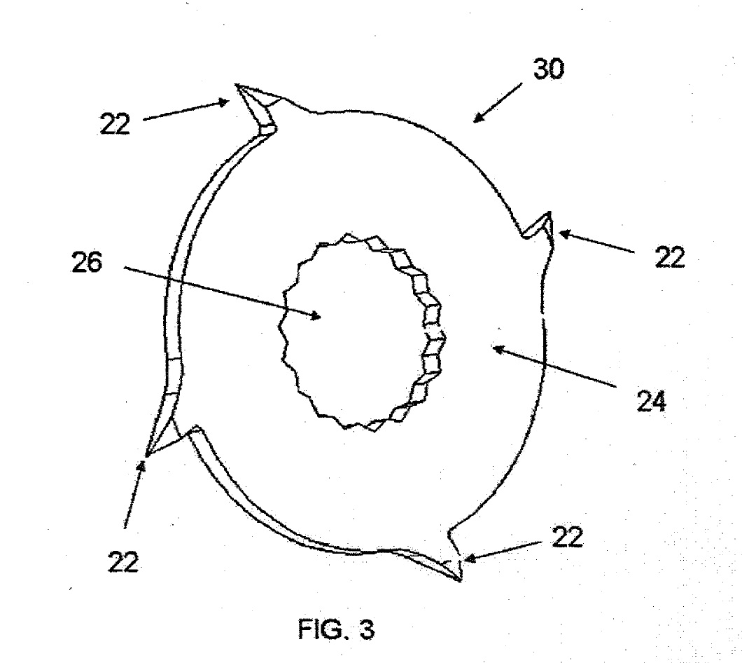

In an embodiment of the invention, a blade set is formed from two blades—a notched blade and a mating blade—combined together. FIG. 2 is an example of the notched blade (20). FIG. 3 is an example of the mating blade (30). FIG. 2 and FIG. 3 identify four knife edges (22) as one embodiment of the invention.

Each blade is approximately disc shaped, but the shape can vary as long as the shape is functional within a paper shredder. Each blade has a body (24) and an opening or hole (26) in approximately the center of the body to accommodate a cutting arbor. The sides of each blade has a flat surface. As is shown in the Figures, no portion of the blade protrudes over either flat surface of the blade.

Turning to FIG. 2, the notched blade has a notch cut (28) in the body of the blade extending from a point in the body of the blade to the center hole (26). In the embodiment being addressed there are two notches (28) and the notches are on opposing sides of the center hole (26). In other embodiments there can be more than two notches with a variety of locations around the center hole.

Addressing FIG. 3, the mating blade does not have a notch cut.

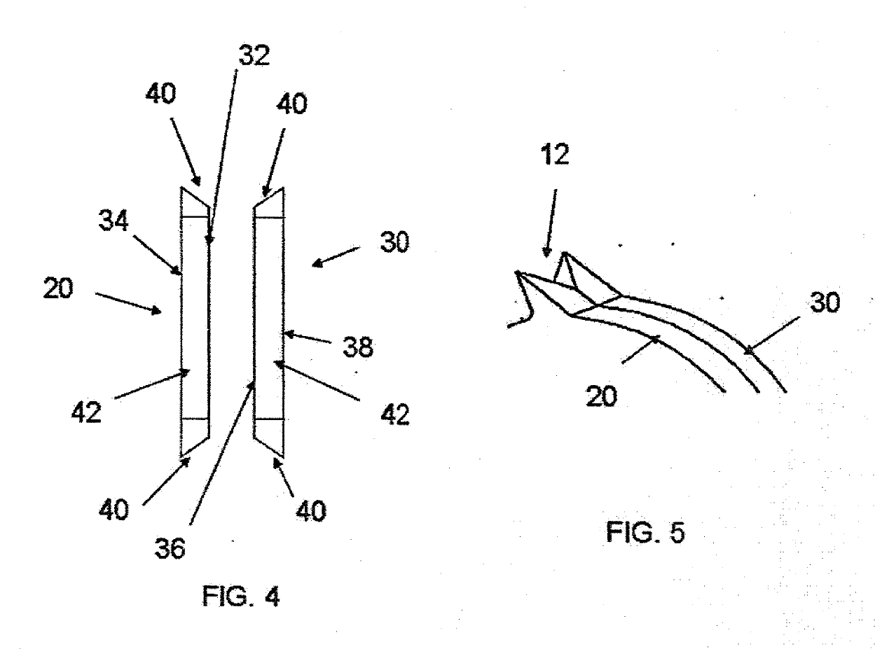

FIG. 4 shows opposing flat surfaces for each blade and an outer periphery. The notched blade (20) has a first s flat surface (32) and a second flat surface (34). The mating blade (30) also has a first flat surface (36) and a second flat surface (38). Each blade has at least two slanted cutting points (40) on the outer periphery (42) of the body of the blade and the cutting points are disposed generally opposite one another on the periphery. In other embodiments, the cutting points could take shapes other than being slanted and more than two blade knives could be used.

In FIG. 5, the notched blade (20) and the mating blade (30) are in contact in such a way as to result in a V shaped blade (12).

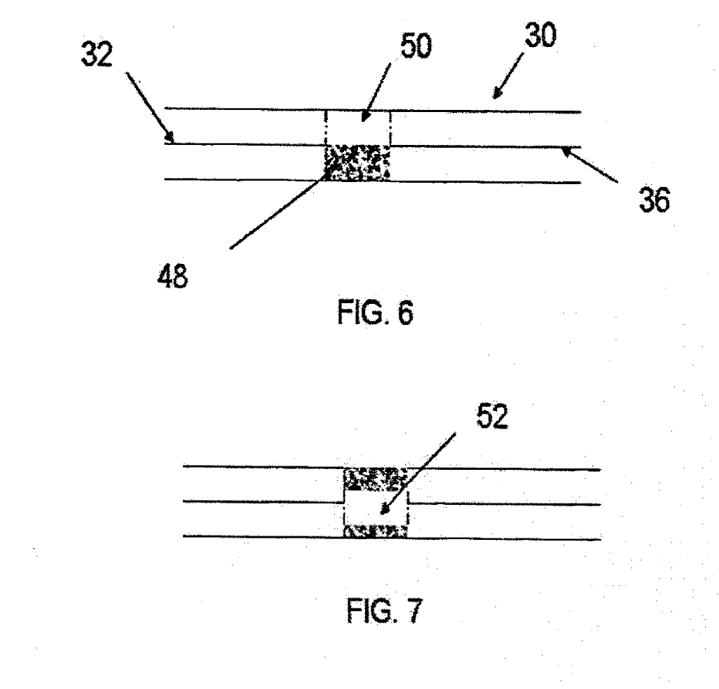

FIG. 6 identifies the notch blade (20) in proximity with the mating blade (3) with the first flat surfaces of each blade in contact. The notch (48) is shown as is the area in the mating blade (50) that is over the notch.

Addressing FIG. 7, in the current embodiment, force is applied to the area of the mating blade (50) over the notch such that material (52) is displaced into some portion of the notch (48) of FIG. 6. The displaced material (52) is still connected to some degree with the mating blade (30). The material (52) within the notch (48) secures the notch blade (20) to the mating blade (3) and the result is the blade set, fixed by a notched blade lock.

The material in the notch (52) can be described as a press or friction fit such that the notch blade (20) and mating blade (30) are held together. The tightness can be regulated as desired in a particular application. Thermal expansion or contraction can also be employed in other embodiments to vary the allowance.

In another embodiment, the notch could be formed by removing material from the body of the notched blade to the periphery. Forcing the material from the mating blade into the notch would proceed in generally the same fashion as identified above.

In another embodiment, holes could be formed through the opposing sides of one blade instead of using notches. Again, the material from the mating blade could be forced into the hole in generally the same fashion as identified above.

In yet another embodiment, combinations of holes and/or notches could be used to join the blades into a blade set.

As used herein, the term “notched blade locking” denotes the notched blade-and-mating blade affixing techniques described above, particularly with respect to FIGS. 6-7, although techniques described relative to FIGS. 2-5 also may be used.

Grooved incisor shredder blades, formed with a relief channel, can provide advantages over common shredder blades, such as blade set 10 in FIG. 1. The grooved incisor blade means may take on plural configurations, each with a groove being juxtaposed with a crown. Cutting forces on the crown can be “relieved” by the presence of the groove (also called a “relief groove”), allowing easier cutting by the shredder blades. The empty space formed by a relief groove can be called a relief channel. In general, the relief groove is disposed to relieve forces imposed on a blade crown during cutting of paper, by providing an outlet (relief channel) for the cut paper, or shreddant, to be easily forced from the region of the cutting incisors. It has been found that, by the addition of a groove, paper cutting pressures can be reduced by between about 20% to about 45%, putting less stress on the cutting crowns, the shredder motor, and the shredder motor-to-blade gear train. In addition, in some embodiments, the addition of a groove tends to increase the maximum number of sheets able to be cut at a particular time. A crown is formed with a predetermined crown height (h), and a predetermined crown beam (w), typically a few millimeters each. Typically, grooved incisor blades are solid and do not contain central recesses.

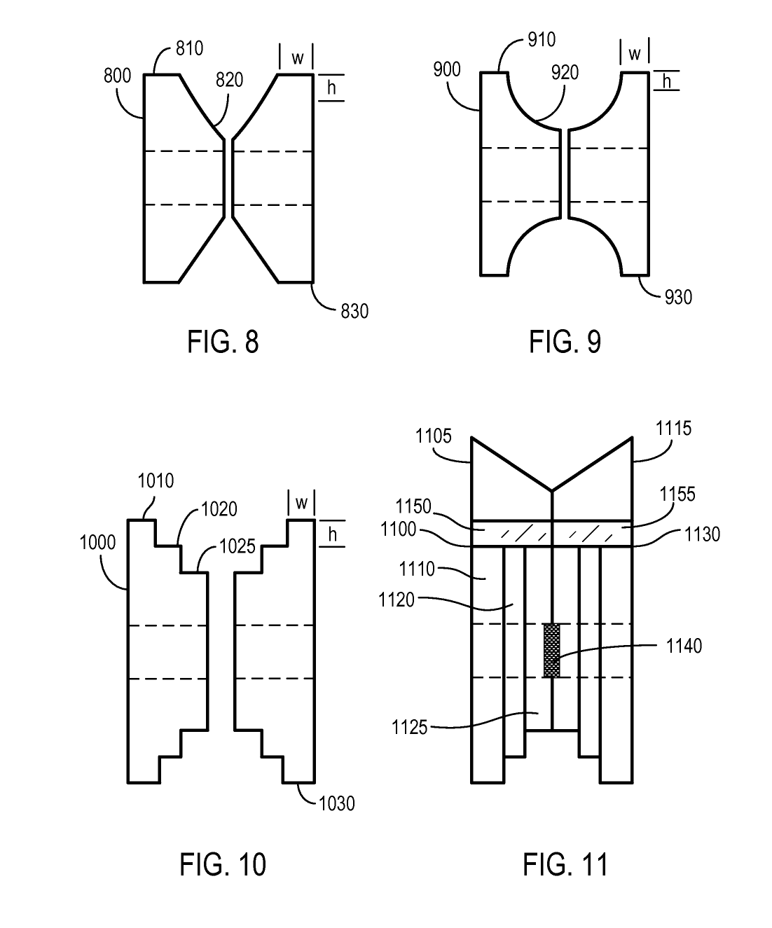

The pressing of a crown can make the crown denser, and more resistant to damage from paper clips, staples, and minor detritus, although other techniques may be used. Crown height may vary with the form of the groove. A narrower crown beam can allow for increased efficiency but may face an increased likelihood of crown damage during use, limiting the product lifespan. As is shown by the Figures, crown beam can be defined on one side by flat surface at the side of a blade. A relief groove can be formed by one or more steps juxtaposed with a crown, providing a generally V-shaped profile (FIG. 8), a generally U-shaped profile (FIG. 9), or a stair-step profile (FIGS. 10-13). A wider groove creates a wider relief channel, generates less resistance to turning, produces easier cutting, reduces the force needed to shear the paper, and reduces the stress on the gears and components of the shredder power train. In turn, the shredder operates more quietly with a potentially increased lifespan, and is more economical.

Useful shredder blade metals include, without limitation, steels such as cold rolled carbon steel (SPCC), or manganese steel, with a Rockwell hardness (HRB) of between about 68 HRB to about 95 HRB. When lower HRBs are used (about 68), the blades may require a form of heat treatment. However, narrower crowns tend to warp with heat treatment, and narrow, softer incisors may be less useful for high-performance products.

FIG. 8 illustrates, in edge view, an alternative embodiment of an arcuate-grooved incisor, in which grooved incisor shredder blade 800 includes crown 810, and arcuate relief groove 820. In this embodiment, groove 820 can have an arcuate shape that is closer to a V-shape than a U-shape. The space formed by the arcuate relief groove in the metal forms a relief channel in which shreddant may be conveyed during paper cutting. Crown 810 may have a predetermined crown height (h) and a predetermined crown beam (w). Blade 830 may be affixed to blade 800, for example, by notched blade locking, to form a grooved incisor blade assembly.

FIG. 9 illustrates, in edge view, an alternative embodiment with arcuate grooved incisor blade 900 having crown 910 and relief groove 920. Crown 910 can have a predetermined incisor height (h) and predetermined incisor beam (w). In this embodiment, arcuate relief groove 920 can be U-shaped. Blade 900 can be affixed to blade 930, for example, by notched blade locking, to form a grooved incisor blade assembly.

FIG. 10 illustrates, in edge view, a stepped groove incisor blade 1000 in accordance with an embodiment. Crown 1010 is juxtaposed with a stepped relief groove 1020 cut into the metal and forming a relief channel. Crown 1010 is formed with a predetermined crown height (h) and crown beam (w). In the course of stamping grooved incisor blade 1000, crown 1010 is the densest portion of blade 1000 and first groove step 1020 is a less dense portion of the blade due to stamping techniques employed in the formation of blade 1000. Second groove step 1025 can be stamped providing a wider relief channel using plural grooves. Second groove step 1025 can be less dense again than crown 1010 but still sufficiently strong to provide high performance. Cutting blade 1000 can be affixed to cutting blade 1030 to form a cutting blade assembly (e.g., FIG. 11), for example, by notched blade locking.

Although crowns 810, 910, and 1010, are shown as having flat-cut edges on the crown beam, a crown also can have a bevel or a protruding edge on a side of the crown beam. The sides of each blade has a flat surface. As is shown in FIGS. 8-10, no portion of the blade protrudes over either flat surface of the blade. A beveled edge to a crown may provide additional cutting force because of an increased relief channel area for shreddant removal.

FIG. 11 illustrates, in assembled view, a stepped groove incisor blade 1100 having a cutting point 1105 formed thereupon. Blade 1100 is shown coupled to blade 1130 having cutting point 1115. Incisor blade 1100 can have crown 1110, first stepped groove 1120, and second stepped groove 1125, with each step groove providing additional relief space. Cutting points, 1105, 1115 may be representative of points disposed along the periphery of a cutting blade to provide aggressive cross-cut shredding, which is assisted by the grooves 1120, 1125 in removing the shreddant from the cutting blade area. Blade 1100 and 1130 may be formed with a built-up dam 1150, 1155 advanced from the leading edges of cutting points 1105, 1115 to help facilitate pushing shreddant through the relief channel. Blade 1100 and like blade 1130 can be affixed to form a grooved incisor blade assembly having a stepped relief groove, for example, by notched blade locking 1140. Blade 1100 can be tightly linked and affixed to blade 1130. Indeed, in an embodiment, blade pair 1100, 1130, can be affixed by a notch-link 1140, using the notch linking method described and illustrated with respect to FIG. 6 and FIG. 7. Each of the blade pairs 800, 830, 900, 930, and 1000, 1030 may be affixed to form a respective grooved incisor blade assembly, using the notched blade locking technique illustrated with respect to FIG. 6 and FIG. 7.

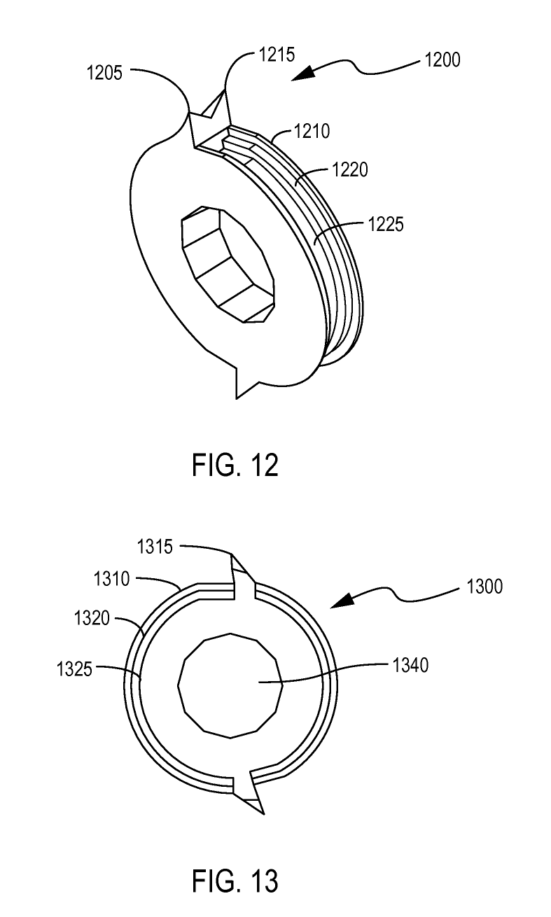

FIG. 12 is a perspective view of a blade fabricated in accordance with FIG. 11, with FIG. 13 being a side cut-away view of FIG. 11 and FIG. 12. In blade assembly 1200, cutting points 1205, 1215 provide for cross-cutting of the shreddant, while crown portions 1210 of assembly 1200 periphery perform straight-cuts of the shreddant. As is shown in FIG. 12, no portions protrude over, or from, the blade flat side surfaces. As with FIG. 11, FIG. 12 exhibits a first stepped groove 1220 on each side and a mutual second groove 1225, together forming a relief channel for shreddant. FIG. 13 is a side cut-away view of FIG. 12 and also may be seen as a side view of the right-side blade of FIG. 8. Grooved incisor blade 1300 includes crown 1310, first relief groove step 1320 and second relief groove step 1325. In addition, assembly channel 1340 can be seen, which is adapted to receive a cutting arbor.

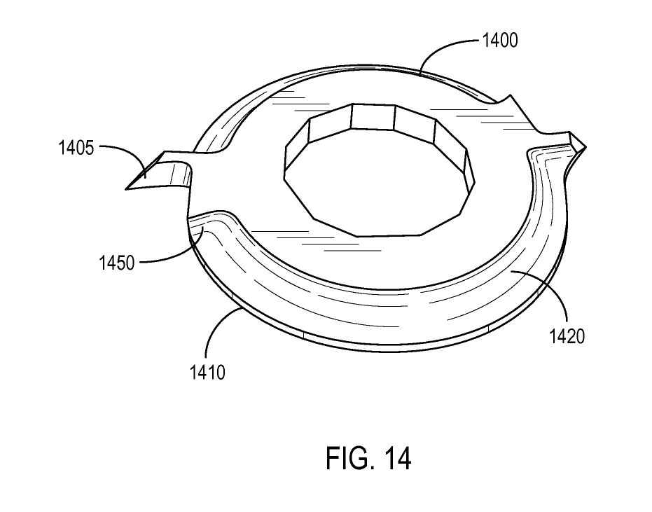

FIG. 14 is a perspective view of a grooved incisor blade 1400 having a cutting point 1405 and a dam 1450 advanced from the cutting point 1405. Grooved incisor blade 1400 can be configured with a beveled cutting point, and can have an arcuate groove 1420 juxtaposed with crown 1410. Crown 1410 may have straight-cut edge on the crown beam, but also may be the crown beam slanted (i.e., beveled). Dam 1450, similar to dam 1150 in FIG. 11, can serve as a surface which augments movement of shreddant through relief channel formed by the grooved blade 1400.

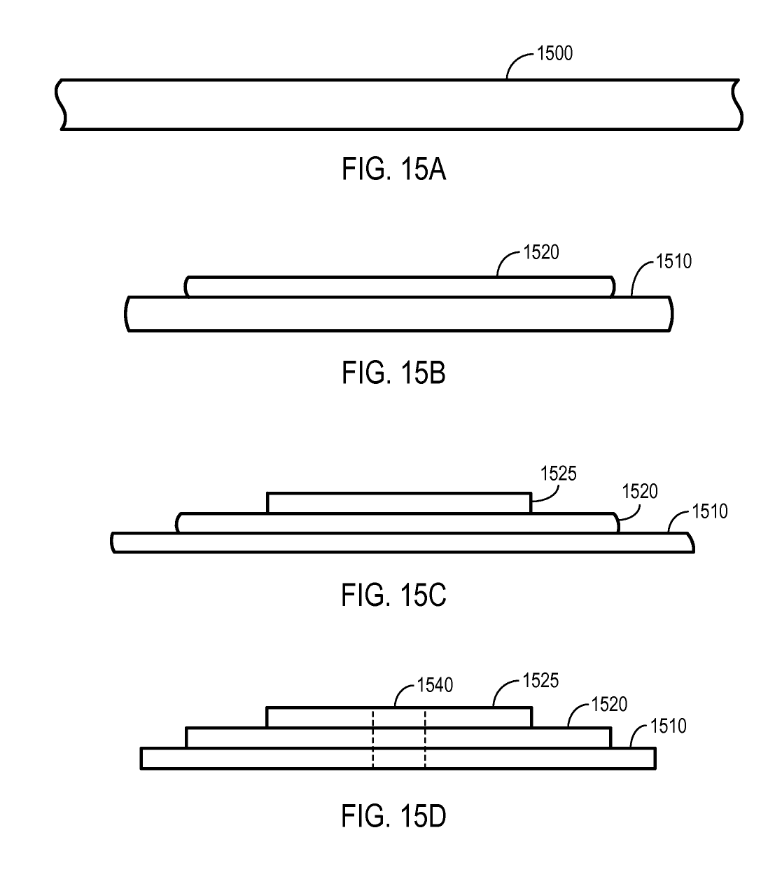

A pictorial format of a method embodiment for forming a blade of FIG. 8 and FIG. 13 can be illustrated in FIG. 15A-15D. A grooved incisor blade with stepped groove 1500 may be formed by providing a strip of metal 1500 (FIG. 15A), forming a crown 1510 (FIG. 15B), forming a first relief groove step 1520 (FIG. 15B), forming a second relief groove 1525 distal to the crown and proximal to the first relief groove 1520 (FIG. 15C), and then trimming away excess metal (FIG. 15D). A central assembly channel 1540 also may be made to receive a cutting arbor.

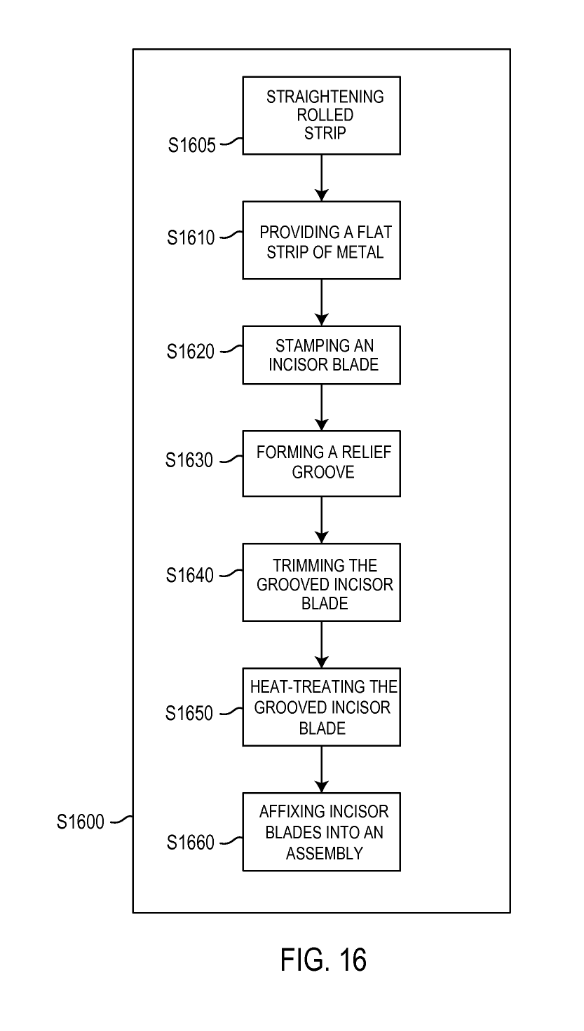

A general method embodiment for forming grooved incisor shredder blades (S1600) can be explained with the assistance of FIG. 16. The method may proceed by providing a strip of metal (S1610), forming a crown (S1620) in the strip of metal, forming a relief groove in juxtaposition to the crown (S1630), and trimming a first grooved incisor blade of excess material (S1640). Forming a relief groove (S1630) may include forming one or more incremental steps, which steps may be rectilinear or may be curvilinear, in accordance with the ultimate relief groove shape intended. Forming (S1630) and trimming (S1640) may be performed by stamping, punching, or forging.

The method further may include heat-treating a grooved incisor blade (S1650), where the blade is made of SPCC steel or manganese steel. Due to spreading forces encountered from shreddant, it may be desirable to hold firmly together the blades in an assembly of two or more blades. Affixing the blades (S1660) using the notched blade locking techniques described with respect to FIG. 6 and FIG. 7 may be performed. As a preliminary step, where the blade metal is formed from rolled steel strips, the method may include straightening the rolled steel into a crown strip (S1605). Heat-treating can be an optional step, depending upon the narrowness of the incisor beam. Additional formation techniques for grooved incisor blades are possible, in addition to the general method 1600 shown in FIG. 16. The sides of each blade has a flat surface. No portion of the blade protrudes over either flat surface of the blade.

While embodiments have been described in detail, it should be appreciated that various modifications and/or variations may be made without departing from the scope or spirit of the invention. In this regard it is important to note that practicing the invention is not limited to the applications described herein above. Many other applications and/or alterations may be utilized provided that such other applications and/or alterations do not depart from the intended purpose of the invention. Also, features illustrated or described as part of one embodiment may be used in another embodiment to provide yet another embodiment such that the features are not limited to the embodiments described herein above. Thus, it is intended that the invention cover all such embodiments and variations. Nothing in this disclosure is intended to limit the scope of the invention in any way.

1. A shredder blade, comprising:
a single piece disk-shaped body having an external face with a first flat surface, an internal face with a second flat surface opposite the external face and the first flat surface, and an circumferential periphery with a thickness;
a central hole in the disk-shaped body penetrating the external and internal faces, without a spacer portion;
a cutting crown protruding from the circumferential periphery of the disk-shaped body;
a cutting tip extending from the cutting crown body and not protruding over the external face or the internal face;
a grooved portion in the circumferential periphery extending at least partly through the thickness from the exterior face to the interior face, the grooved portion being a relief groove; and
a dam raised up from the grooved portion and transverse on the circumferential periphery adjacent to the cutting crown,
wherein the grooved portion relieves cutting forces on the cutting crown.

2. The shredder blade of claim 1, wherein the grooved portion is one of a rectilinear shape or a curvilinear shape.

3. The shredder blade of claim 2, wherein the grooved portion is a curvilinear shape and further comprises an arcuate shape.

4. The shredder blade of claim 2, wherein the grooved portion is a rectilinear shape and further comprises a stair-step shape.

5. The shredder blade of claim 2, wherein the crown portion is a straight-cut crown.

6. The shredder blade of claim 2, wherein the crown portion comprises a beveled edge.

7. The shredder blade of claim 2, wherein the crown portion of the blade further comprises a cutting point.

8. The shredder blade of claim 7, wherein the crown portion of the blade further comprises a dam advanced from the cutting point.

9. The shredder blade of claim 2, wherein the crown portion of a blade is formed with a predetermined height, and a predetermined beam.

10. A blade assembly comprising:
a first crown portion of a first disk-shape blade body;
a first groove portion in a circumferential periphery of the first disk-shaped blade body juxtaposed with the first crown portion;
a second groove portion in a circumferential periphery of a second disk-shaped blade body in apposition to the first groove portion of the first disk-shaped blade body; and
a second crown portion of the second disk-shaped blade body juxtaposed with the second groove portion of the second disk-shaped blade body, wherein the first blade body is affixed to the second blade body, and wherein each side of the blade assembly is flat and no portion protrudes over either flat side.

11. The blade assembly of claim 10, wherein the first crown portion, the first groove portion, the second groove portion, and the second crown portion form a stepped shape.

12. The blade assembly of claim 10, wherein the first crown portion, the first groove portion, the second groove portion, and the second crown portion form a V-shape shape.

13. The blade assembly of claim 10, wherein the first crown portion, the first groove portion, the second groove portion, and the second crown portion form a U-shape shape.

14. The blade assembly of claim 10, further comprising:
a cutting point on each of the first crown portion and the second crown portion; and
a dam advanced from the cutting point.

15. A method for forming shredder cutting blades comprising:
providing a strip of metal;
forming a crown in the strip of metal;
forming a relief groove juxtaposed to the crown in the strip of metal, wherein a relief channel is formed thereby; and
trimming the blade of excess metal, wherein a grooved incisor blade is formed.

16. The method of claim 15, further comprising:
affixing first and second grooved incisor blades into an assembly, wherein affixing is effected by notched blade locking.

17. The method of claim 15, further comprising:
straightening a rolled strip of metal before providing a strip of metal.

18. The method of claim 15, further comprising:
heat-treating the grooved incisor blade.

19. The method of claim 15, wherein the forming the incisor comprises:
stamping the crown.

20. The method of claim 15, wherein the forming the relief groove comprises:
stamping the relief groove juxtaposed to the crown in one of a rectilinear or a curvilinear shape.

21. A shredder blade, comprising:
cutting crown means; and
relief groove means juxtaposed with the cutting crown means and forming a relief channel thereby, wherein the cutting crown means and the relief groove means are formed from a single piece of metal, and wherein the shredder blade is a grooved incisor blade.

22. The shredder blade of claim 21, further comprising:
dam means transverse to the cutting crown means beam and the relief groove means.

23. The shredder blade of claim 21, further comprising cutting point means disposed generally transverse to the cutting crown means and to the relief groove means with the dam means being disposed advanced of the cutting point means.

24. A paper shredder blade set comprising:
a first disk-shaped body having a first flat external surface, a first flat internal surface opposite the first flat external surface, and an circumferential periphery therebetween;
a central hole in the disk-shaped body through the external and internal surfaces, adapted to receive a cutting arbor and having a notch in the body to the central hole;
a first crown portion of a first blade, wherein a side of the first crown portion is the first flat external surface, the first crown portion having two knife edges and a first incisor blade a portion of the first incisor blade extending at an angle from the flat internal surface to the flat external surface of the first crown portion and forming a first cutting point;
a first groove portion of the first blade formed in the circumferential periphery and juxtaposed with a first incisor portion forming a notched grooved incisor blade;
a second disk-shaped body having a second flat external surface, a second flat internal surface opposite the second flat external surface, and an circumferential periphery therebetween;
a second central hole in the second disk-shaped body through the second external and internal surfaces, adapted to receive a cutting arbor, forming a mating grooved incisor blade;
a second groove portion of the mating grooved incisor blade in apposition to the first groove portion of the notched grooved incisor blade,
a second crown portion of a second blade, juxtaposed with the second groove portion of the second blade, wherein a side of the second crown portion is the second flat external surface, the second crown portion having two knife edges, and a portion of the second incisor blade extending at an angle from the flat internal surface to the flat external surface, and forming a second cutting point, wherein the internal surfaces of the first and second blades are in contact forming a mated grooved incisor blade,
wherein the cutting point of the first grooved incisor blade is aligned with the cutting point of the second grooved incisor blade such that each of the cutting points align with the other of the cutting points, and a groove is formed therebetween,
wherein no portion protrudes over either external flat surface; and
an amount of the material from the body of the mating grooved incisor blade is disposed within the notch of the notched grooved incisor blade such that a portion of the amount of material in the notch remains attached to the mating grooved incisor blade, and the notched grooved incisor blade and the mating grooved incisor blade are substantially secured to one another.

25. The blade set of claim 24 wherein each of the cutting points being slanted such that the alignment of the cutting points on the notched grooved incisor blade and the mating grooved incisor blade form a blade set with a V shaped blade.

26. A paper shredder blade set comprising:
a notched grooved incisor blade having a substantially round and flat shaped body, a first and second opposing flat sides, a center hole adapted to receive a cutting arbor, at least two cutting points disposed on a periphery of the body, and at least two notches with each notch extending from a point in the body through the periphery and through the flat sides;
a mating grooved incisor blade having a substantially round and flat shaped body, a first and second opposing flat sides, a center assembly hole adapted to receive a cutting arbor, and at least two knife edges disposed on a periphery of the body; the first flat side of the notched grooved incisor blade contacting the first flat side of the mating grooved incisor blade such that each of the cutting points on the notched grooved incisor blade substantially align with a corresponding cutting point on the mating grooved incisor blade; and
an amount of the material from the body of the mating blade being disposed within the notch of the notched grooved incisor blade such that a portion of the material in the notch remains attached to the mating grooved incisor blade and the notched grooved incisor blade and the mating grooved incisor blade are substantially secured to one another, and a groove is formed therebetween.

27. The blade set of claim 26 wherein each of the cutting points are slanted such that the alignment of the knife edges on the notched grooved incisor blade and the mating grooved incisor blade form a blade set with a V shaped blade.

28. A method of manufacturing a paper shredder blade set using a notched grooved incisor blade having a substantially round and flat shaped body, a first and second opposing flat sides, a center hole adapted to receive a cutting arbor, at least two cutting points disposed on a periphery of the body, and at least two notches with each notch extending from a point in the body through the periphery and through the flat sides, and a mating grooved incisor blade having a substantially round and flat shaped body, a first and second opposing flat sides, a center hole adapted to receive a cutting arbor, and at least two cutting points disposed on a periphery of the body, comprising:
placing the first flat side of the notched grooved incisor blade in contact with the first flat side of the mating grooved incisor blade such that each of the cutting points on the notched grooved incisor blade substantially align with a corresponding cutting point on the mating grooved incisor blade; and
applying force to the second side of the mating grooved incisor blade in a location generally opposite the notch in the notched grooved incisor blade such that an amount of the material from the body of the mating grooved incisor blade is disposed within the notch of the notched grooved incisor blade such that a portion of the material in the notch remains attached to the mating grooved incisor blade and the notched grooved incisor blade and the mating grooved incisor blade are substantially secured to one another, and a groove is formed therebetween, wherein no portion protrudes over either external flat surface.

29. A method of manufacturing a paper shredder blade set using a notched grooved incisor blade having a substantially round and flat shaped body, a first and second opposing flat sides, a center hole adapted to receive a cutting arbor, at least two cutting points disposed on a periphery of the body, and at least two notches with each notch extending from a point in the body through the center hole and through the flat sides, and a mating grooved incisor blade having a substantially round and flat shaped body, a first and second opposing flat sides, a center hole adapted to receive a cutting arbor, and at least two cutting points disposed on a periphery of the body, comprising:
placing the first flat side of the notched grooved incisor blade in contact with the first flat side of the mating grooved incisor blade such that each crown on the notched grooved incisor blade substantially align with a corresponding crown on the mating grooved incisor blade; and
applying force to the second side of the mating grooved incisor blade in a location generally opposite the notch in the notched grooved incisor blade such that an amount of the material from the body of the mating grooved incisor blade is disposed within the notch of the notched grooved incisor blade such that a portion of the material in the notch remains attached to the mating grooved incisor blade, the notched grooved incisor blade and the mating grooved incisor blade are substantially secured to one another, and a groove is formed between the notched grooved incisor blade and the mating grooved incisor blade, wherein no portion protrudes over an external flat surface.
